(19) United States
(12) Patent Application Publication
(10) Pub. No.: US 2016/0358284 A1
(43) Pub. Date: Dec. 8, 2016

(54) COMPUTERIZED SYSTEM AND METHOD FOR CODING MEDICAL RECORDS

(71) Applicant: Scott Bagley, Louisville, KY (US)

(72) Inventor: Scott Bagley, Louisville, KY (US)

(73) Assignee: HUMANA INC., Louisville, KY (US)

(21) Appl. No.: 13/276,741

(22) Filed: Oct. 19, 2011

(51) Int. Cl. G06Q 50/24

(52) U.S. Cl. CPC G06Q 50/22

(57) ABSTRACT

A computerized system and method for medical record coding is disclosed. The computerized system and method facilitates pre-screening of medical records and analyzes medical record data to identify potential coding errors. When potential coding errors are identified in a record, the suspect record is forwarded to a certified medical coder to confirm the presence or absence of the error. In an example embodiment, synonyms likely to be found in medical records are associated with standardized medical terms and codes and stored in a database. The computerized system and method searches electronic records using the synonyms. If a synonym is present in a record, the system identifies an appropriate code for the associated medical condition confirms that the appropriate medical code is associated with the record. If the code is not found, appropriate action is taken to correct the coding error. Multiple levels of review may be applied to each record.

### CROSS-REFERENCE TO RELATED APPLICATIONS

None.

### BACKGROUND OF THE INVENTION

To facilitate reimbursements to healthcare providers, organizations such as the Center for Medicare Services (CMS) and other payors require coding of medical records. Coding classifications, such as CMS's hierarchical condition categories (HCC), are used to identify numerous clinical diagnoses or medical conditions relevant to a patient's health. When healthcare claims coding was first adopted in the health benefits industry, the coding was typically performed by a certified medical record coder. The coder would review the patient's medical record data and apply codes to the record and/or correct codes that appear suspicious for a variety of reasons. For example, a code related to chronic pulmonary heart disease for a patient that has never been diagnosed with a heart problem may reflect a coding error. In other instances, a relevant code (e.g., code for a diagnosis of diabetes) may be absent. The record may be flagged with by the coder for further action to correct the coding problem. If the coder determined there were no additional conditions that needed to be identified on the medical record, the record was summarily dismissed (“No Action”).

Certified medical coders review a substantial number of records every day but the volume of medical records that many health benefits providers need to process increases every year. Unless the health benefits provider is able to increase the number of coders in proportion to the increase in the volume of records, the percentage of records that are reviewed declines. As a result, claims processing, medical risk adjustment, and other functions involving medical records are delayed until the coding errors are uncovered and corrected.

Although certified medical record coders are skilled at identifying coding errors within a record, it is impossible for them to review every medical record received by the health benefits provider. The volume of records—which increases every year—is simply too great to be reviewed manually. Therefore, there is a need for an automated system and method to identify records that may have coding errors and that could be forwarded to a medical record coder for review and further processing. There is a need for an automated system and method to distinguish medical records that are more likely to have coding errors from records that are less likely to have coding errors. There is a need for an automated system and method to pre-screen medical records and establish a priority for manual review of records by coders. There is further a need for an automated system and method that is easily modified to include additional information about codes and related health care information to facilitate pre-screening and review of records.

### SUMMARY OF THE INVENTION

The present disclosure is directed to a computerized system and method medical record coding. The computerized system and method facilitates pre-screening of medical records and analyzes medical record data to identify potential coding errors in records. When potential coding errors are identified in a record, a suspect code indicator may be associated with the record and the suspect record may be forwarded to a certified medical coder to confirm the presence or absence of the error. The computerized system and method facilitates the creation and editing of a library of information to further facilitate review and analysis of medical record data.

In an example embodiment, the computerized system and method identifies records that have sufficient textual detail to further allow the detection of possible medical record coding errors. In an example embodiment, the computerized system and method applies a test for “overlooked” information within a record. Because the disclosed system and method employs computer technology, additional medical conditions that manual coders simply do not have time to locate can be considered in the initial review and analysis of a record. As a result, the number of medical records that can be reviewed and verified and/or corrected is increased substantially. Because the number of records that may be reviewed and corrected is increased substantially, fewer processing delays result from coding errors. Furthermore, records that are unlikely to have suspect coding are not forwarded to human coders thereby allowing the coders to spend more time on records that are likely to have errors. For health benefit providers that partner with CMS, the disclosed computerized system and method allows the providers to identify medical conditions of members that need to be reported to CMS to ensure proper calculation of the member's risk score.

### BRIEF DESCRIPTION OF THE DRAWINGS

FIG. 1 is a flow diagram of a medical records processing system with text mining features according to an example embodiment;

FIGS. 2A and 2B are an example of electronic data for developing a data dictionary according to an example embodiment;

FIGS. 3A-3E are examples of additional electronic data for the data dictionary according to an example embodiment;

FIG. 4 is an example of nearness patterns involving a patient's family history.

### DETAILED DESCRIPTION

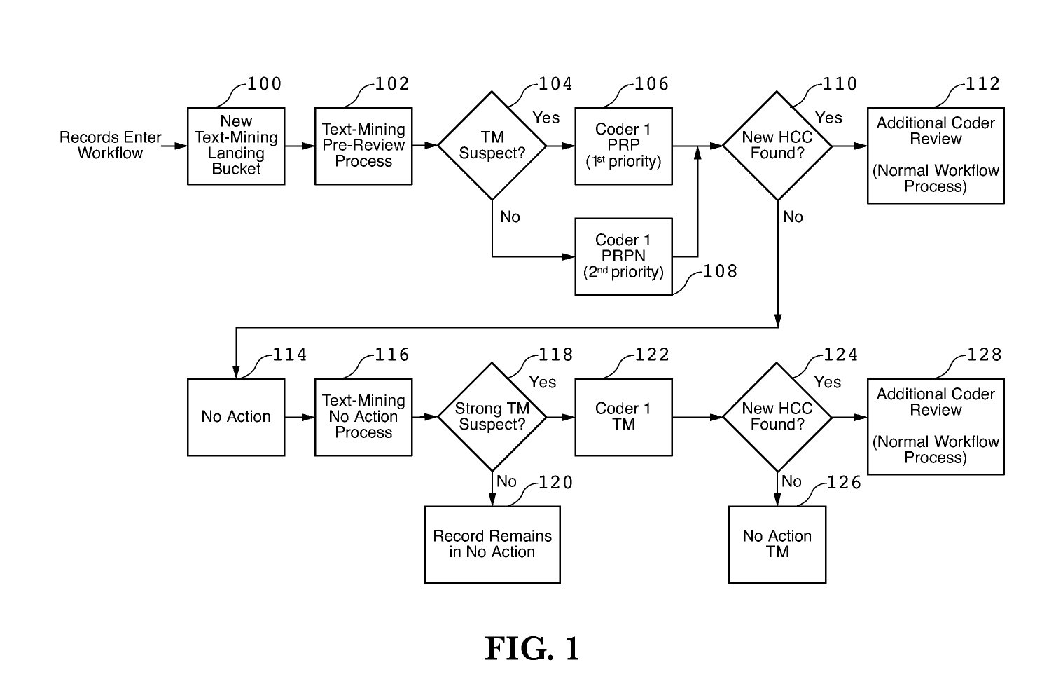

Referring to FIG. 1, a flow diagram of a medical records processing system with text mining features according to an example embodiment is shown. Electronic medical records are transmitted by hospitals, physician offices, and other healthcare providers and arrive at a text mining application site 100 where they are held for further processing. The electronic records typically arrive in an image format such as TIFF. The records, which may be one page or hundreds of pages in length, are processed through an optical character recognition application to facilitate parsing and searching of the records by the text mining pre-review application 102.

The pre-review application 102 searches the pages of each record to identify medical conditions the patient may have but have not been coded on the record. If the text mining pre-review application 102 identifies a suspect record 104 (e.g., incorrect code or absent code), the record is flagged as suspect or “prospective review positive-PRP” 106. Flagged records may be maintained in a queue or otherwise made accessible to medical record coders for additional review. In an example embodiment, if the record does not appear to have a coding problem 108, it is not flagged as suspect (“prospective review positive not-PRPN”). Suspect or flagged records, and in some instances, unflagged records, are then made available to a medical record coder for additional manual review to confirm the presence or absence of a coding problem. Unflagged records may also remain in a “no action” state. If the medical record coder confirms the error and the need for a new code 110, the record may be submitted to an additional review process 112.

In an example embodiment, if the medical record coder does not agree with the outcome of the pre-review application 114 and concludes “no action” is required, the record is re-submitted to a text mining “no action” application 116 for additional analysis. In the second level of review, a search for “stronger” terms is completed. For example, a first level review may involve a search for the term “emphysema.” In a second level review, the text mining “no action” application 116 may search for the terms “patient has emphysema.” If the text mining application finds the stronger terms in the record 118, the record is flagged again for review by a medical record coder 122. If the stronger terms are not present in the record, the record remains in a “no action” state 120.

If the medical record coder confirms the need for a new code 124, the record proceeds through the normal workflow process and an additional review is conducted 128. If the medical record coder confirms there is no need for a new code or other coding change, the record remains in a “no action” state 126.

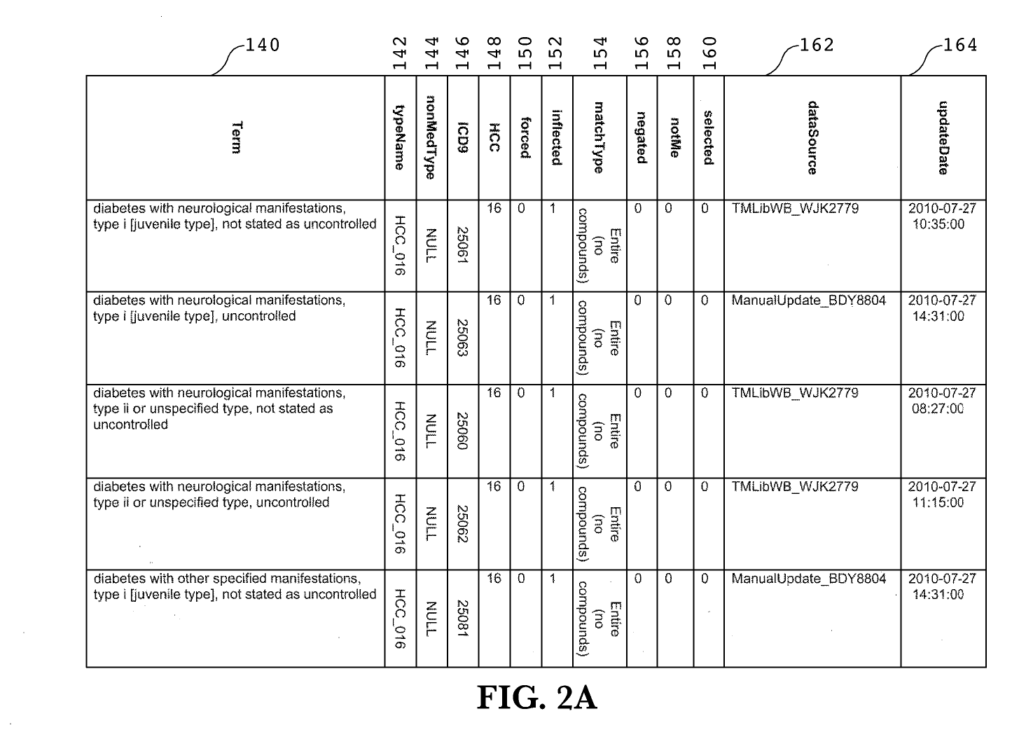

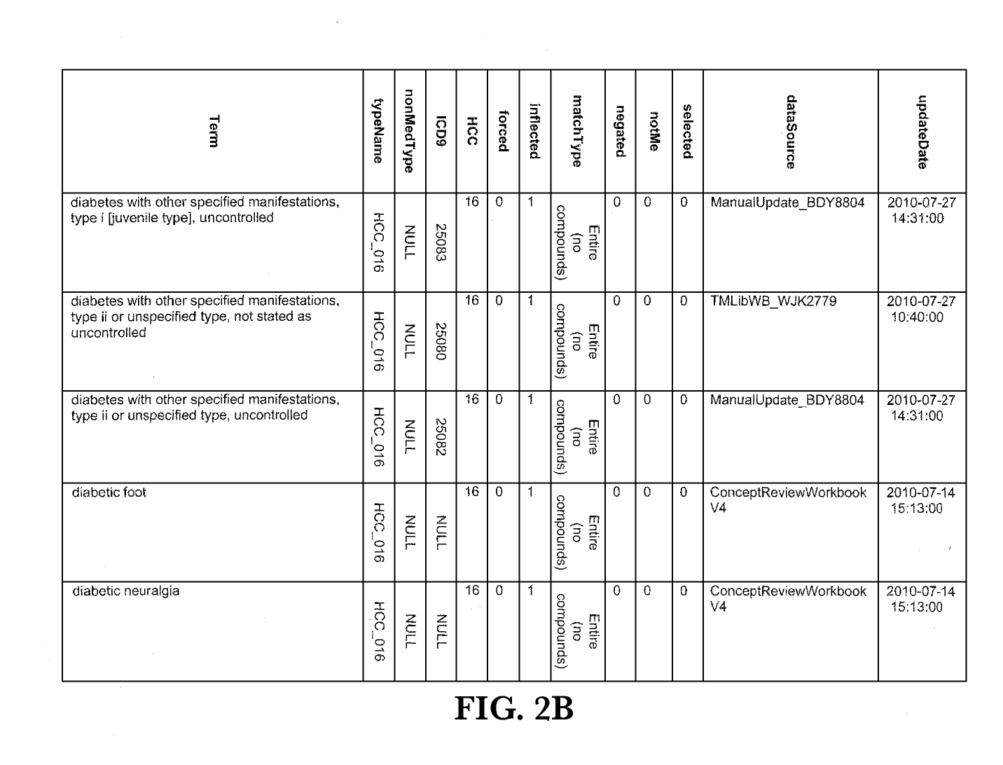

Referring to FIGS. 2A and 2B, an example of electronic data for developing a data dictionary according to an example embodiment is shown. The example data comprises standardized text data (terms or phrases) for medical conditions 140 and related code and other data for each condition. In the example, textual descriptions of diabetes conditions are shown. The example data in the table also comprises a data source 162 and update date 164. In an example embodiment, the electronic data of FIGS. 2A and 2B is organized according to the following fields:

[Please confirm the following descriptions are correct or provide descriptions if blank.]

TABLE 1
Description of Data Elements

| Primary Terms or | Brief description of medical condition |
|---|---|
| Concepts (Phrases) | |
| 140 | |
| Type Name | Code based name for medical condition |
| 142 | |
| Non-Medical Type | Non-medical type indicator for text data not |
| 144 | related to patient medical condition |
| ICD9 Code | Related code from International Classification |
| 146 | of Disease Codes |
| HCC | Related code from CMS Hierarchical Classification |
| 148 | Code for Risk Adjustments |
| Forced | Indicates this term exists in collocated dictionaries. |
| 150 | Typically application is to common language that |
| | needs to be treated specially for medical records. |
| Inflected | Indicates is inflection rules should be applied during |
| 162 | extraction |
| Match Type | Indicator for type of match (e.g., entire, exact, |
| 154 | partial, etc.) |
| Negated | Flag to (temporarily) exclude term from extractions |
| 156 | |
| Not Me | Indicator for conditions related to patient |
| 158 | |
| Selected | If the term is forced, indicates if this dictionary's |
| 160 | term/type is selected. |
| Data Source | File identifying data source |
| 162 | |
| Update Date | Update date for data source |
| 164 | |

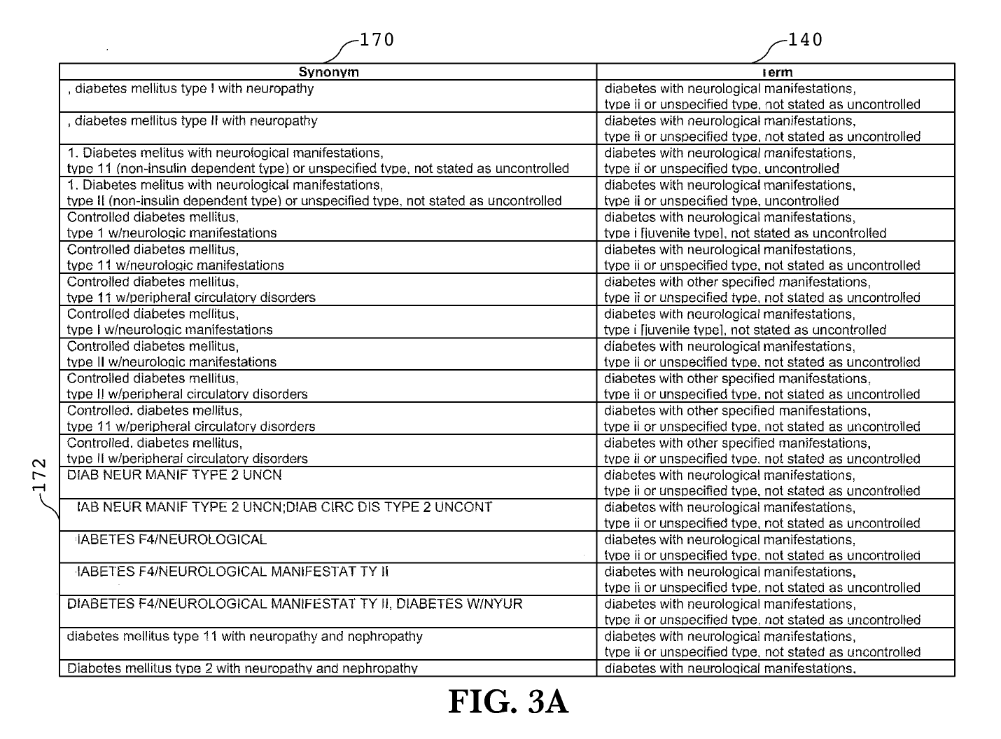

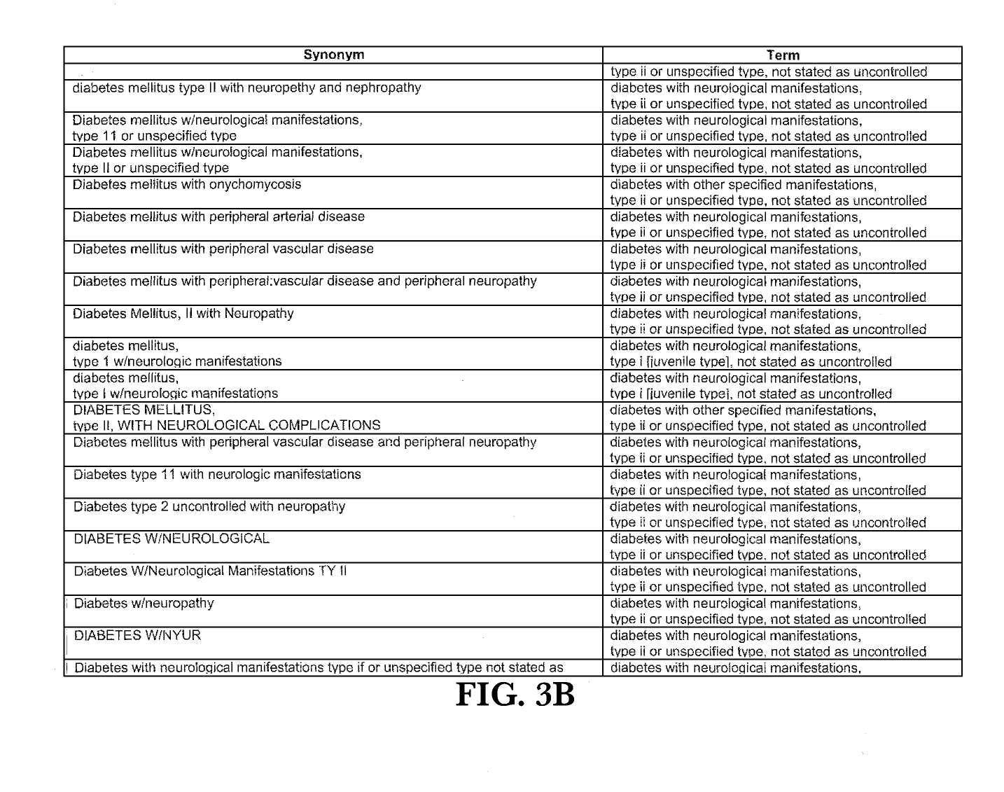

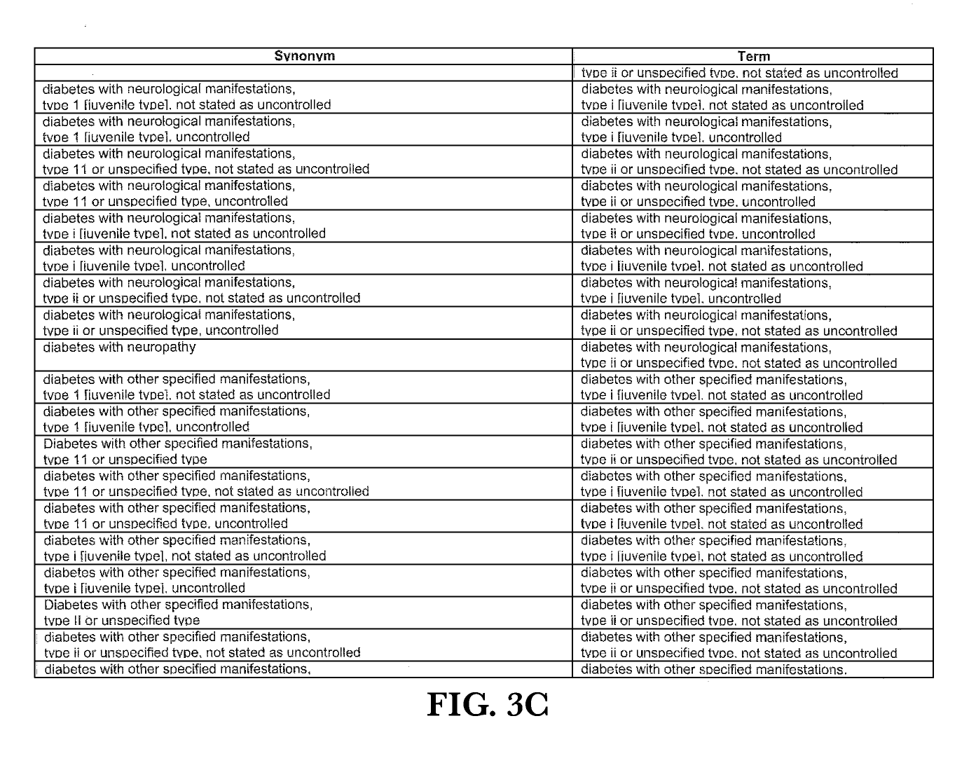

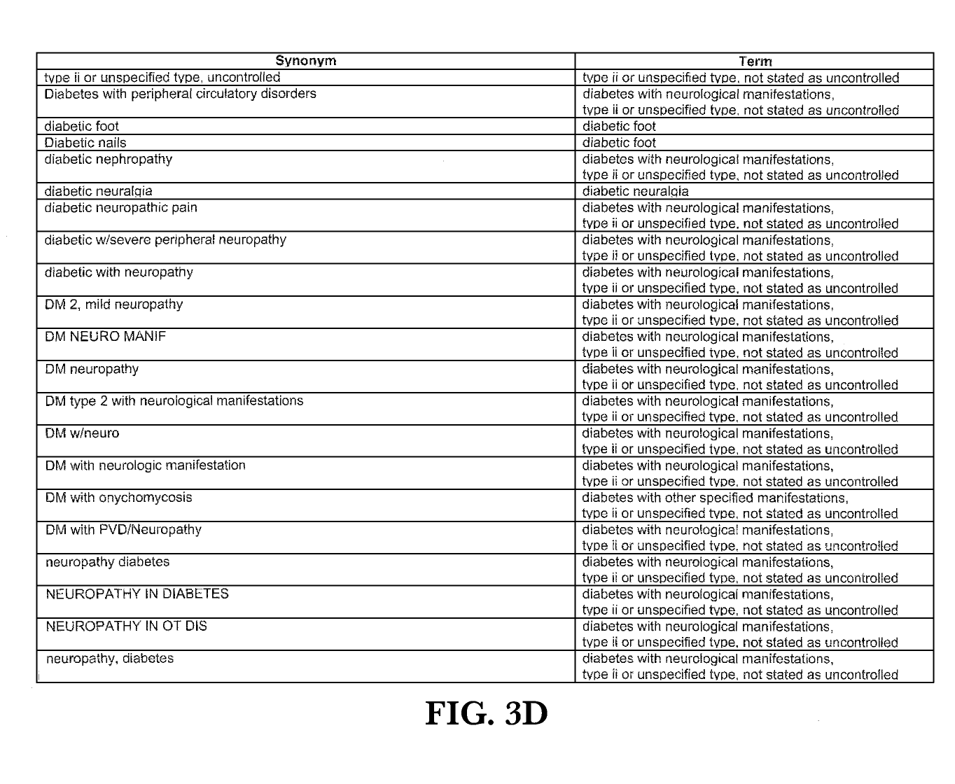

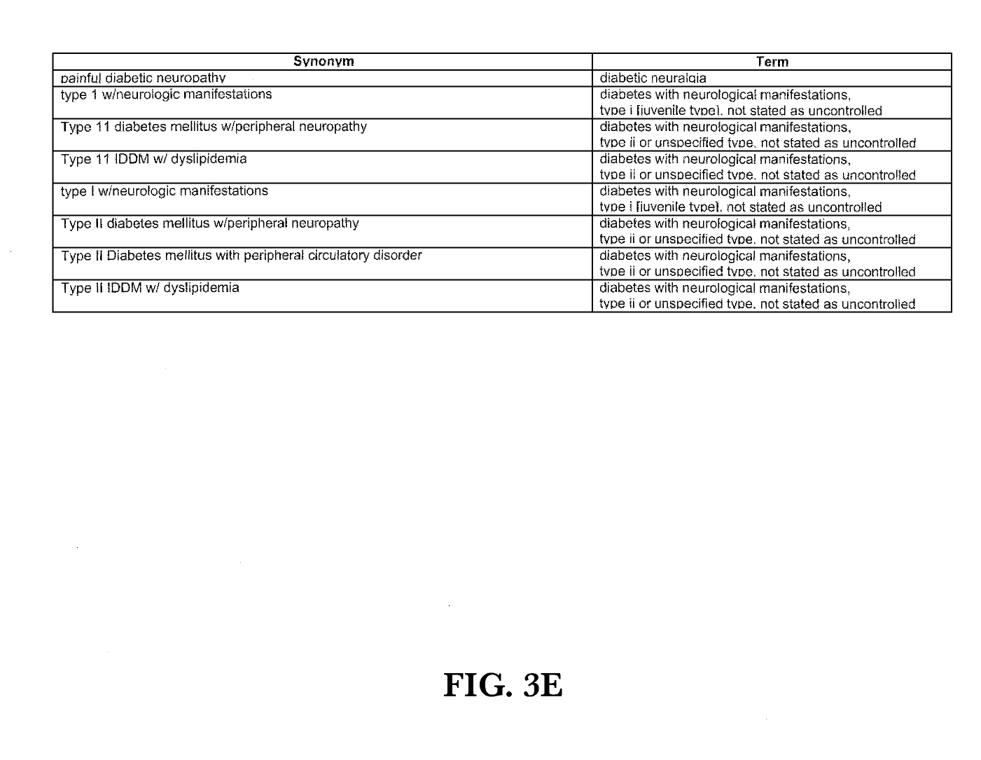

Referring to FIGS. 3A-3E, additional electronic data for the data dictionary is shown. The data in FIGS. 3A-3D lists for each standardized term 140 from FIGS. 2A-2B related synonyms. The synonyms are used in searching records and facilitate matching of medical records with proper codes. The synonyms comprise descriptions for medical conditions as they are typically recorded in medical records by healthcare providers and practitioners. The synonyms may be derived from actual medical records or other sources and therefore, reflect actual terminology and language found in healthcare records. As indicated in the synonym column 170 of the table, providers and practitioners often use abbreviations or shorthand terms to describe relevant medical conditions. For example, “DIAB NEUR NAMIF TYPE 2 UNCN; DIAB CIRC DIS TYPE 2 UNCONT” may be considered equivalent to a standardized term “diabetes with neurological manifestations, type ii or unspecified type, not stated as uncontrolled.” As the data in the table also indicates, “type ii” may be recorded as “type 11,” “type II,” or “type 2.” Each healthcare provider or practitioner that creates or updates medical records may adopt its own conventions for taking and recording patient and family histories, complaints, and symptoms as well as recording related medical conditions, diagnoses, treatments, prognoses, etc. The synonyms, therefore, account for the varied ways in which a single condition may be recorded and described in medical records from numerous providers.

In addition to accounting for the various ways in which a single condition may be described and recorded, the synonyms facilitate location of information that is likely to be relevant to the patient's actual health status. Although each medical record may be very long—in some cases hundreds of pages—the relevant medical information may be contained within a proportionately small number of pages. Each record may comprise pages with patient contact information, demographic data, HIPAA forms, procedure consent forms, and a substantial amount of textual data not directly relevant to the patient's health status. Therefore, the presence of a medical term within the Record—“pneumonia,” for example—may or may not be indicative of the patient's health condition. Because many of the synonyms comprise phrases or terminology that is likely to be used by the physician or other individual providing the healthcare services to the patient, the likelihood of finding relevant medical conditions is increased.

The text mining “pre-review” and “no action” processes of FIG. 1 parse and search each incoming medical record to locate the presence of one or more synonyms. The presence of one or more synonyms may then be used to identify the related HCC code or codes that should be associated with the record. The synonym data may be updated as new terminology and language for known conditions is encountered as a result of the review process.

In an example embodiment, a greedy lookahead tokenizer algorithm is applied to incoming records. Each record is examined for the presence of a plurality of medical conditions that may be applicable to the patient. The algorithm builds matches into an extraction for the record by extending the match according to terms from the applicable synonym. The algorithm continues searching the record for synonyms for each medical condition until it finds a match or concludes there are no matches and therefore, the condition is not present. As indicated in FIGS. 3A-3E, a plurality of synonyms correspond to a standardized medical term. As portions of the record are matched with a synonym, the extraction is updated with supporting language from the record and the record is tokenized according to the match. In an example embodiment, the token is an ICD9 or HCC code for the standardized medical term identified in the match with a synonym.

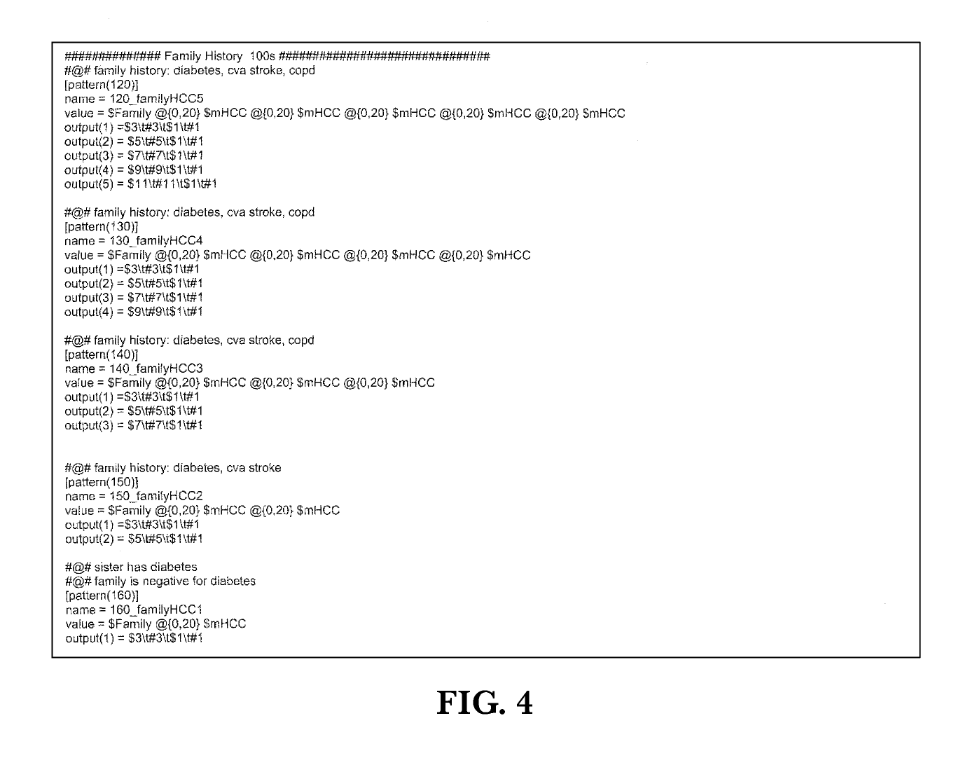

Referring to FIG. 4, the electronic data dictionary further comprises a collection of relationships, or “nearness patterns” used to identify when key concepts or terms are found adjacent to or near one another in the record. Tokenized records are analyzed according to the “nearness patterns.” Using the tokens in the records (e.g., the codes for one or more suspected medical conditions), the “nearness patterns” for identified conditions are applied to locate additional supporting language in the record for the suspected conditions. The “nearness” of key data elements is useful in determining whether a particular medical condition is actually relevant to a patient. For example, the words “assessment” or “assessed” in close proximity to the word “diabetes” suggests a positive diagnosis of diabetes for the patient. Analyzing records for the proximity of certain words, terms, or phrases within each record increases the accuracy of the system because medical records may contain many medical terms that are not relevant to a patient's health status. For example, many consent forms that are part of a medical record may list certain medical conditions that are side effects of a procedure (e.g., dizziness, nausea) rather than indicative of a patient's current condition. The nearness patterns may be used to discern whether certain medical conditions as identified in the tokenized record are actually relevant to the patient status. Alternatively, certain medical terms or phrases may simply be present in the record for other reasons.

“Negative” nearness patterns may be used to confirm that patient does not have a medical condition. The example nearness patterns of FIG. 4 relate to patterns involving a patient's family history. The proximity of the words “father,” “mother,” “brother,” or “sister” to a specified medical condition (e.g., diabetes) in the record may be an indication that another family member, and not the patient, has the medical condition. The absence of any other indicators that the patient actually has the condition may lead to a conclusion that the patient does not have the condition despite the presence of the terms for the medical condition within the record. Such information, therefore, may be used to determine the patient does not have the suspected medical condition. The “nearness patterns,” whether positive or negative, may further increase the accuracy of the system.

Records that have been labeled “suspect” or otherwise flagged for manual review may be made accessible to a certified medical coder to determine whether the record should be coded with additional medical condition codes. The coder may review the results of the automated analysis in which suspect medical codes with supporting language are identified and confirm that the recorded should be coded as indicated or that the record does not support the addition of the suspect medical codes.

The text mining functionality described herein may be implemented using IBM® SPSS® predictive analytics software. Data dictionary functionality may be provided using Microsoft® SQL Server. While certain embodiments of the present invention are described in detail above, the scope of the invention is not to be considered limited by such disclosure, and modifications are possible without departing from the spirit of the invention as evidenced by the claims. For example, medical term, synonym, and code data may be organized across tables in numerous ways and fall within the scope of the invention. Other aspects of the text mining functionality may be varied and fall within the scope of the claimed invention. Records may be coded automatically rather than flagged for review. One skilled in the art would recognize that such modifications are possible without departing from the scope of the claimed invention.

1. A computerized method to identify medical record coding errors comprising:
(a) storing in a database:
(1) a plurality of medical phrases identifying medical conditions; and
(2) in association with each medical phrase, a medical code;
(b) storing in said database in association with each medical phrase a plurality of synonyms;
(c) receiving at a server text data for an electronic medical record;
(d) searching at said server said text data for a first one of said synonyms;
(e) in response to locating said first synonym in said text data:
(1) adding to an extraction for said electronic medical record supporting language for said first synonym;
(2) locating from said database at least one medical code associated with said first synonym; and
(3) searching at said server said text data for presence of said medical code;
(f) in response to confirming said medical code is not present in said electronic medical record,
(1) flagging said electronic medical record with a suspect code indicator; and
(2) transferring said electronic medical record to a queue accessible to a medical record coder to:
(i) review said extraction and said electronic medical record; and
(ii) confirm said medical code should be added to said electronic medical record or flag said electronic medical record with a no action indicator;
(g) in response to said medical record coder flagging said electronic medical record with a no action indicator:
(1) searching at said server said text data for at least one phrase comprising said first one of said synonyms;
(2) in response to locating said at least one phrase comprising said first synonym in said text data, updating said no action indicator to said suspect code indicator;
(h) transferring said electronic medical record to said queue accessible to said medical record coder to confirm said medical code should be added to said electronic medical record; and
(i) adding said medical code to said electronic medical record.

2. (canceled)

3. (canceled)

4. The computerized method of claim 1 wherein said medical code is selected from the group consisting of:
hierarchical clustering codes and International Statistical Classification of Diseases codes.

5. The computerized method of claim 1 further comprising:
(j) searching said text data of said electronic medical record using a plurality of nearness patterns for said medical code.

6. The computerized method of claim 5 wherein said nearness patterns comprise negative nearness patterns to confirm a medical condition is not relevant to said patient.

7. (canceled)

8. The computerized method of claim 1 wherein said phrase comprises words relevant to a plurality of synonyms.

9. (canceled)

10. A computerized system to identify medical record coding errors comprising:
(a) a database storing:
(1) a plurality of medical phrases identifying medical conditions;
(2) in association with each medical phrase, a medical code; and
(3) in association with each medical phrase a plurality of synonyms;
(b) a server executing programming instructions to:
(1) receive text data for an electronic medical record;
(2) search for a first synonym in said text data of said electronic medical record;
(3) in response to locating said first synonym in said text data of said electronic medical record:
(i) adding to an extraction for said electronic medical record supporting language for said first synonym;
(ii) locate from said database at least one medical code associated with said first synonym; and
(iii) search said text data using a nearness pattern for presence of said medical code;
(4) in response to confirming said medical code is not present in said electronic medical record,
(i) flag said electronic medical record with a suspect code indicator; and
(ii) transfer said electronic medical record to a queue accessible to a medical record coder to:
(A) review said extraction and said electronic medical record; and
(B) confirm said medical code should be added to said electronic medical record or flag said electronic medical record with a no action indicator;
(5) in response to said medical record coder flagging said electronic medical record with a no action indicator:
(i) searching at said server said text data for at least one phrase comprising said first one of said synonyms; and
(ii) in response to locating said at least one phrase comprising said first synonym in said text data, updating said no action indicator to said suspect code indicator;
(6) transfer said electronic medical record to said queue accessible to said medical record coder to confirm said medical code should be added to said electronic medical record; and
(7) add said medical code to said electronic medical record.

11. (canceled)

12. (canceled)

13. The computerized system of claim 10 wherein said medical code is selected from the group consisting of: hierarchical clustering codes and International Statistical Classification of Diseases codes.

14. (canceled)

15. The computerized system of claim 10 wherein said nearness pattern is a negative nearness pattern applied to said medical code to confirm said patient does not have a related medical condition.

16. (canceled)

17. The computerized system of claim 10 wherein said phrase comprises words relevant to a plurality of synonyms.

18. (canceled)

19. A computerized method to identify electronic medical records with medical coding errors comprising:
(a) storing in a database:
(1) a plurality of medical phrases identifying medical conditions; and
(2) in association with each medical phrase, a medical code;
(b) storing in said database in association with each medical phrase a plurality of synonyms;
(c) receiving at a server text data for at least a first electronic medical record and a second electronic medical record;
(d) searching at said server said text data for presence of at least one of said plurality of synonyms in said first electronic medical record and said second electronic medical record;
(e) in response to locating at least one of said plurality of synonyms in text data for said first electronic medical record, locating from said database said medical code associated with said synonym and tokenizing said text data according to said medical code said medical code;
(1) in response to confirming said medical code is not present in said first said electronic medical record:
(i) adding to an extraction for said first electronic medical record supporting language according to said synonym;
(ii) flagging at said server said first electronic medical record with a suspect code indicator; and
(iii) transferring at said server said first electronic medical record to a queue accessible to a medical record coder; and
(2) in response to confirming said medical code is present in said second electronic medical record:
(i) leaving said electronic medical record in a no action state;
(ii) searching at said server said text data for at least one phrase comprising said one of said plurality of synonyms;
(iii) in response to locating said at least one phrase in said text data, updating said no action indicator to said suspect code indicator; and
(iv) transferring said electronic medical record to said queue accessible to said medical record coder to confirm said medical code should be added to said electronic medical record.

20. (canceled)
